(19) United States
(12) Patent Application Publication
(10) Pub. No.: US 2024/0039351 A1
(43) Pub. Date: Feb. 1, 2024

(54) ROTOR OF ROTATING ELECTRICAL MACHINE

(71) Applicant: KABUSHIKI KAISHA TOYOTA JIDOSHOKKI, Aichi (JP)

(72) Inventor: Yoshihiro KATAGIRI, Aichi (JP)

(73) Assignee: KABUSHIKI KAISHA TOYOTA JIDOSHOKKI, Aichi (JP)

(21) Appl. No.: 18/267,906

(22) PCT Filed: Nov. 12, 2021
(86) PCT No.: PCT/JP2021/041708

§ 371 Date: Jun. 16, 2023

(30) Foreign Application Priority Data
Dec. 21, 2020 (JP) 2020-211799

(51) Int. Cl. H02K 1/28

(52) U.S. Cl. CPC H02K 1/28

(57) ABSTRACT

A rotor of a rotating electrical machine includes a cylindrical member; a magnetic material disposed inside the cylindrical member; a shaft member disposed on at least one of opposite ends of the cylindrical member in an axial direction of the cylindrical member and fixed to an inner peripheral surface of the cylindrical member with the shaft member located adjacent to the magnetic material in the axial direction of the cylindrical member; and a welding portion via which the cylindrical member and the shaft member are welded together. The shaft member has a fitting portion that is press-fitted onto the inner peripheral surface of the cylindrical member. The fitting portion is located closer to the magnetic material than to the welding portion. The welding portion is spaced from the fitting portion in the axial direction.

### TECHNICAL FIELD

The present invention relates to a rotor of a rotating electrical machine.

### BACKGROUND ART

A rotor of a rotating electrical machine, disclosed in Patent Literature 1, for example, includes a cylindrical member, a magnetic material arranged in the cylindrical member, and a shaft member disposed on at least one of opposite ends of the cylindrical member in an axial direction and fixed to the inner peripheral surface of the cylindrical member with the shaft member disposed adjacent to the magnetic material in the axial direction. The cylindrical member suppresses deformation of the magnetic material receiving a centrifugal force generated by rotation of the rotor. The shaft member has a fitting portion that is press-fitted onto the inner peripheral surface of the cylindrical member. Press-fitting the fitting portion onto the inner peripheral surface of the cylindrical member causes the shaft member to be fixed to the inner peripheral surface of the cylindrical member. In order to ensure the fixing of the shaft member to the cylindrical member, the shaft member may be considered to be connected to the cylindrical member, for example, by welding, in addition that the fitting portion is press-fitted onto the inner peripheral surface of the cylindrical member. As such, the rotor may have a welding portion via which the cylindrical member and the shaft member are welded together.

### CITATION LIST

### Patent Literature

Patent Literature 1: Japanese Patent Application Publication No. 2004-112849

### SUMMARY OF INVENTION

### Technical Problem

Press-fitting the fitting portion of the shaft member onto the inner peripheral surface of the cylindrical member causes the cylindrical member to be subjected to fitting stress from the fitting portion. If the welding portion is not spaced from the fitting portion in the axial direction of the cylindrical member and is continuous to the fitting portion in the axial direction of the cylindrical member, the fitting stress applied to the cylindrical member from the fitting portion easily transfers to the welding portion, and the welding portion may therefore be subjected to the fitting stress applied to the cylindrical member from the fitting portion. This may decrease the strength of the connection between the shaft member and the cylindrical member via the welding portion, and therefore may decrease the reliability of the rotor of the rotating electrical machine.

### Solution to Problem

A rotor of a rotating electrical machine to solve the aforementioned problem includes a cylindrical member; a magnetic material disposed inside the cylindrical member; a shaft member disposed on at least one of opposite ends of the cylindrical member in an axial direction of the cylindrical member and fixed to an inner peripheral surface of the cylindrical member with the shaft member located adjacent to the magnetic material in the axial direction of the cylindrical member; and a welding portion via which the cylindrical member and the shaft member are welded together, the shaft member has a fitting portion that is press-fitted onto the inner peripheral surface of the cylindrical member, the fitting portion is located closer to the magnetic material than to the welding portion, and the welding portion is spaced from the fitting portion in the axial direction.

According to this configuration, the welding portion is spaced from the fitting portion in the axial direction of the cylindrical member, so that the fitting stress applied to the cylindrical member from the fitting portion is unlikely to transfer to the welding portion. This prevents the welding portion from being subjected to the fitting stress applied from the fitting portion to the cylindrical member, thereby suppressing the decrease of the strength of the connection between the shaft member and the cylindrical member via the welding portion. As a result, this increases the reliability of the rotor of the rotating electrical machine.

In the rotor of the rotating electrical machine, the shaft member may have a small-diameter portion that has a dimension smaller than a dimension of the fitting portion in a radial direction of the cylindrical member and is disposed inside the cylindrical member, and the small-diameter portion may be disposed between the fitting portion and the welding portion in the axial direction.

According to this configuration, the small-diameter portion is disposed between the fitting portion and the welding portion in the axial direction of the cylindrical member, so that the welding portion may be spaced from the fitting portion without a design change of the cylindrical member.

In the rotor of the rotating electrical machine, the shaft member may be an output shaft that is configured to output a drive force.

According to this configuration, the welding portion via which the cylindrical member and the output shaft are welded together is spaced from the fitting portion in the axial direction of the cylindrical member, and this configuration prevents the welding portion from being subjected to the fitting stress applied from the fitting portion to the cylindrical member. This configuration therefore suppresses the decrease of the strength of the connection between the output shaft, which is likely to be subjected to a load, and the cylindrical member via the welding portion. As a result, this increases the reliability of the rotor of the rotating electrical machine.

In the rotor of the rotating electrical machine, the welding portion may be spaced from the fitting portion in the axial direction so that stress applied to the welding portion during rotation of the rotor is a local minimum value.

During the rotation of the rotor, the welding portion is subjected to another stress caused by a centrifugal force generated by the rotation of the rotor. When the welding portion is spaced from the fitting portion in the axial direction of the cylindrical member so as to prevent the welding portion from being subjected to the fitting stress applied to the cylindrical member from the fitting portion, the welding portion is only subjected to the stress caused by the centrifugal force generated by the rotation of the rotor, which causes the stress applied to the welding portion to be the local minimum value. Accordingly, the welding portion is spaced from the fitting portion in the axial direction of the cylindrical member so that the stress applied to the welding portion during the rotation of the rotor is the local minimum value. This configuration allows the welding portion to be only subjected to the stress caused by the centrifugal force generated by the rotation of the rotor when the rotor rotates, thereby further suppressing the decrease of the strength of the connection between the shaft member and the cylindrical member. This configuration therefore further increases the reliability of the rotor of the rotating electrical machine.

### Advantageous Effects of Invention

This invention may increase the reliability.

### BRIEF DESCRIPTION OF THE DRAWINGS

FIG. 1 is a sectional view of a rotating electrical machine according to an embodiment.

FIG. 2 is a fragmentary sectional view of a rotor.

FIG. 3 is a graph showing a measurement result of stress applied to a cylindrical member at several points from a first welding portion to a part of the cylindrical member facing a first fitting portion of the cylindrical member in a radial direction of the cylindrical member during rotation of the rotor.

### DESCRIPTION OF EMBODIMENTS

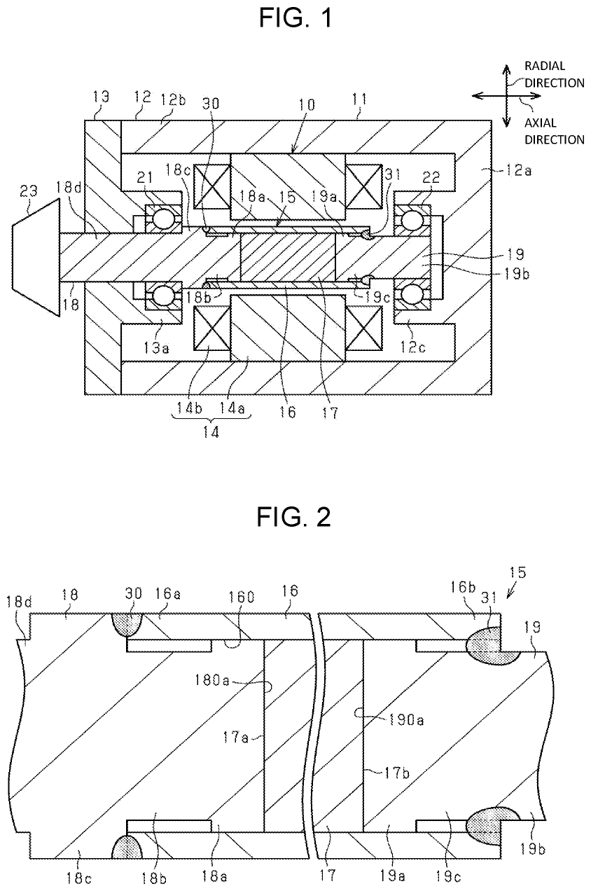

The following will describe an embodiment of a rotor of a rotating electrical machine with reference to accompanying FIGS. 1 to 3.

As illustrated in FIG. 1, a rotating electrical machine 10 is accommodated in a housing 11 having a cylindrical shape. The housing 11 includes a first housing member 12 having a bottomed-cylindrical shape and a second housing member 13 having a plate-like shape and connected to the first housing member 12. The first housing member 12 and the second housing member 13 are made of a metallic material, such as aluminum.

The first housing member 12 has a bottom wall 12a having a plate-like shape and a peripheral wall 12b having a cylindrical shape and extending from an outer peripheral portion of the bottom wall 12a. The second housing member 13 is connected to the first housing member 12 with an opening of the peripheral wall 12b distant from the bottom wall 12a closed by the second housing member 13.

The first housing member 12 has a cylindrical boss 12c protruding from the inner surface of the bottom wall 12a. The axis of the boss 12c corresponds to the axis of the peripheral wall 12b of the first housing member 12. The second housing member 13 has a cylindrical boss 13a protruding from the inner surface of the second housing member 13. The axis of the boss 13a corresponds to the axis of the peripheral wall 12b of the first housing member 12. Accordingly, the axis of the boss 12c corresponds to the axis of the boss 13a.

The rotating electrical machine 10 includes a stator 14 and a rotor 15. The stator 14 includes a cylindrical stator core 14a that is fixed to the inner peripheral surface of the peripheral wall 12b of the first housing member 12, and a coil 14b that is wound around the stator core 14a. The rotor 15 is rotatably disposed radially inside the stator 14 in the housing 11.

As illustrated in FIG. 2, the rotor 15 includes a cylindrical member 16, a permanent magnet 17 serving as a magnetic material, and a first shaft member 18 and a second shaft member 19 serving as a shaft member. In the present embodiment, the cylindrical member 16 is made of Inconel. The cylindrical member 16 has a cylindrical shape such that the axis of the cylindrical member 16 extends linearly. The cylindrical member 16 has a constant thickness.

The permanent magnet 17 has a solid cylindrical shape. The permanent magnet 17 is disposed inside the cylindrical member 16. The axis of the permanent magnet 17 corresponds to the axis of the cylindrical member 16. The permanent magnet 17 is magnetized in the radial direction of the permanent magnet 17. The permanent magnet 17 is press-fitted onto an inner peripheral surface 160 of the cylindrical member 16. The length of the permanent magnet 17 is shorter than the length of the cylindrical member 16 in the axial direction. The permanent magnet 17 has an end face 17a and an end face 17b on opposite sides of the permanent magnet 17 in the axial direction, and the end faces 17a, 17b are flat surfaces extending in a direction perpendicular to the axial direction of the permanent magnet 17.

The end face 17a of the permanent magnet 17 is located inside the cylindrical member 16. Accordingly, a first end 16a of the cylindrical member 16 protrudes from the end face 17a of the permanent magnet 17 in the axial direction. The end face 17b of the permanent magnet 17 is located inside the cylindrical member 16. Accordingly, a second end 16b of the cylindrical member 16 protrudes from the end face 17b of the permanent magnet 17 in the axial direction.

The first shaft member 18 is disposed at the first end 16a of the cylindrical member 16. The first shaft member 18 is made of iron. The first shaft member 18 has a first fitting portion 18a serving as a fitting portion, a first small-diameter portion 18b serving as a small-diameter portion, a first flange portion 18c, and a first shaft portion 18d. The first fitting portion 18a has a solid cylindrical shape. The first fitting portion 18a is press-fitted onto the first end 16a of the cylindrical member 16. Accordingly, the first shaft member 18 is fixed to the inner peripheral surface 160 of the cylindrical member 16. The axis of the first shaft member 18 corresponds to the axis of the permanent magnet 17.

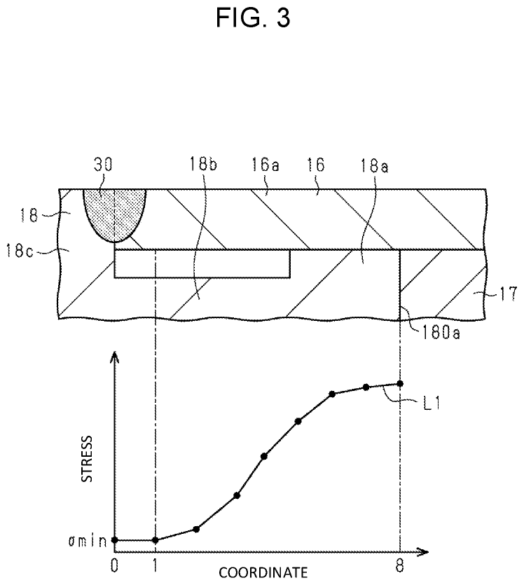

The first small-diameter portion 18b has a solid cylindrical shape. The first small-diameter portion 18b protrudes from an end face of the first fitting portion 18a distant from the permanent magnet 17. The outer diameter of the first small-diameter portion 18b is smaller than the outer diameter of the first fitting portion 18a. Accordingly, the dimension of the first small-diameter portion 18b is smaller than the dimension of the first fitting portion 18a in the radial direction of the cylindrical member 16. The axis of the first small-diameter portion 18b corresponds to the axis of the first fitting portion 18a. The first small-diameter portion 18b is fitted on the inner peripheral surface 160 of the cylindrical member 16 with a gap between the first small-diameter portion 18b and the inner peripheral surface 160. Accordingly, the first small-diameter portion 18b is disposed inside the cylindrical member 16. FIGS. 2 and 3 exaggerate the gap between the first small-diameter portion 18b and the inner peripheral surface 160 of the cylindrical member 16.

The first flange portion 18c has a solid cylindrical shape. The first flange portion 18c continues to an end of the first small-diameter portion 18b distant from the first fitting portion 18a. The outer diameter of the first flange portion 18c is larger than the outer diameter of the first fitting portion 18a. The first shaft portion 18d has a solid cylindrical shape. The first shaft portion 18d continues to an end of the first flange portion 18c distant from the first small-diameter portion 18b. The outer diameter of the first shaft portion 18d is smaller than the outer diameter of the first flange portion 18c.

The second shaft member 19 is disposed at the second end 16b of the cylindrical member 16. The second shaft member 19 is made of iron. The second shaft member 19 has a second fitting portion 19a serving as a fitting portion and a second shaft portion 19b. The second fitting portion 19a has a solid cylindrical shape. The second fitting portion 19a is press-fitted onto the second end 16b of the cylindrical member 16. Accordingly, the second shaft member 19 is fixed to the inner peripheral surface 160 of the cylindrical member 16. The axis of the second shaft member 19 corresponds to the axis of the permanent magnet 17.

The second shaft portion 19b has a solid cylindrical shape. The second shaft portion 19b protrudes from an end face of the second fitting portion 19a distant from the permanent magnet 17. The outer diameter of the second shaft portion 19b is smaller than the outer diameter of the second fitting portion 19a. The axis of the second shaft portion 19b corresponds to the axis of the second fitting portion 19a. A part of the second shaft portion 19b adjacent to the second fitting portion 19a is located inside the cylindrical member 16, and the rest of the second shaft portion 19b protrudes from the cylindrical member 16. Accordingly, the dimension of the part of the second shaft portion 19b adjacent to the second fitting portion 19a is smaller than the dimension of the second fitting portion 19a in the radial direction of the cylindrical member 16, and the part of the second shaft portion 19b is a second small-diameter portion 19c serving as a small-diameter portion disposed inside the cylindrical member 16. The second small-diameter portion 19c is fitted on the inner peripheral surface 160 of the cylindrical member 16 with a gap between the second small-diameter portion 19c and the inner peripheral surface 160. FIG. 2 exaggerates the gap between the second small-diameter portion 19c and the inner peripheral surface 160 of the cylindrical member 16.

The outer diameter of the first fitting portion 18a is equal to the outer diameter of the second fitting portion 19a. The outer diameter of the first small-diameter portion 18b is equal to the outer diameter of the second small-diameter portion 19c. The axis of the first shaft member 18 corresponds to the axis of the second shaft member 19.

The first fitting portion 18a has an end face 180a that is located distant from the first small-diameter portion 18b and is a flat surface extending in a direction perpendicular to the axial direction of the first shaft member 18. The end face 180a of the first fitting portion 18a is in contact with the end face 17a of the permanent magnet 17. Accordingly, the first shaft member 18 is fixed to the inner peripheral surface of the cylindrical member 16 with the first shaft member 18 located adjacent to the permanent magnet 17 in the axial direction of the cylindrical member 16.

The second fitting portion 19a has an end face 190a that is located distant from the second small-diameter portion 19c and is a flat surface extending in a direction perpendicular to the axial direction of the second shaft member 19. The end face 190a of the second fitting portion 19a is in contact with the end face 17b of the permanent magnet 17. Accordingly, the second shaft member 19 is fixed to the inner peripheral surface of the cylindrical member 16 with the second shaft member 19 located adjacent to the permanent magnet 17 in the axial direction of the cylindrical member 16.

As illustrated in FIG. 1, the first shaft portion 18d of the first shaft member 18 passes through the boss 13a and the second housing member 13, and protrudes from the housing 11. A first bearing 21 is disposed between the inner peripheral surface of the boss 13a and the outer peripheral surface of the first shaft portion 18d. The first shaft member 18 is supported by the boss 13a via the first bearing 21, so that the first shaft member 18 is rotatably supported by the housing 11.

The first shaft portion 18d of the first shaft member 18 has an impeller 23 at an end of the first shaft portion 18d distant from the first small-diameter portion 18b. The impeller 23 is rotatable together with the first shaft member 18. The impeller 23 is driven by a drive force generated and transmitted by rotation of the first shaft member 18. Accordingly, the first shaft member 18 provided with the impeller 23 serves as an output shaft that is configured to output the drive force.

The second shaft portion 19b of the second shaft member 19 is inserted in the boss 12c. A second bearing 22 is disposed between the inner peripheral surface of the boss 12c and the outer peripheral surface of the second shaft portion 19b. The second shaft portion 19b is supported by the boss 12c via the second bearing 22, so that the second shaft member 19 is rotatably supported by the housing 11.

As illustrated in FIG. 2, the rotor 15 has a first welding portion 30 that serves as a welding portion via which the cylindrical member 16 and the first shaft member 18 are welded together. The cylindrical member 16 and the first shaft member 18 are connected to each other via the first welding portion 30. The first welding portion 30 is formed at the boundary of the opening end face of the first end 16a of the cylindrical member 16 and the first flange portion 18c connected to each other. Specifically, the opening end face of the first end 16a of the cylindrical member 16 and a part of the first flange portion 18c facing the opening end face of the first end 16a of the cylindrical member 16 in the axial direction of the cylindrical member 16 are melted, and the first welding portion 30 is formed such that the melted portions of them are solidified and connected to each other. Accordingly, the first welding portion 30 is formed extending across the boundary of the opening end face of the first end 16a of the cylindrical member 16 and the first flange portion 18c in the axial direction of the cylindrical member 16, and located between the first end 16a of the cylindrical member 16 and the first flange portion 18c. The center of the first welding portion 30 in the axial direction of the cylindrical member 16 corresponds to the boundary of the opening end face of the first end 16a of the cylindrical member 16 and the first flange portion 18c before the cylindrical member 16 and the first flange portion 18c are connected to each other via the first welding portion 30.

The first fitting portion 18a, the first small-diameter portion 18b, and the first welding portion 30 are arranged in this order from the permanent magnet 17 toward the first end 16a of the cylindrical member 16 in the axial direction of the cylindrical member 16. That is, the first fitting portion 18a is located closer to the permanent magnet 17 than to the first welding portion 30. The first small-diameter portion 18b is located between the first fitting portion 18a and the first welding portion 30. Accordingly, the first welding portion 30 is spaced from the first fitting portion 18a in the axial direction of the cylindrical member 16.

The rotor 15 has a second welding portion 31 that serves as a welding portion via which the cylindrical member 16 and the second shaft member 19 are welded together. The cylindrical member 16 and the second shaft member 19 are connected to each other via the second welding portion 31. The second welding portion 31 is formed where the inner peripheral surface 160 of the cylindrical member 16 and the outer peripheral surface of the second small-diameter portion 19c are connected to each other. Specifically, a part of the opening edge of the second end 16b of the cylindrical member 16 facing the second small-diameter portion 19c in the radial direction of the cylindrical member 16 and a part of the second small-diameter portion 19c facing the opening edge of the second end 16b of the cylindrical member 16 in the radial direction of the cylindrical member 16 are melted, and the second welding portion 31 is formed such that the melted portions of the second end 16b and the second small-diameter portion 19c are solidified and connected to each other. The second welding portion 31 is located between the second end 16b of the cylindrical member 16 and the second small-diameter portion 19c. The second fitting portion 19a, the second small-diameter portion 19c, and the second welding portion 31 are arranged in the axial direction in this order from the permanent magnet 17 toward the second end 16b of the cylindrical member 16. That is, the second fitting portion 19a is located closer to the permanent magnet 17 than to the second welding portion 31. The second small-diameter portion 19c is located between the second fitting portion 19a and the second welding portion 31. Accordingly, the second welding portion 31 is spaced from the second fitting portion 19a in the axial direction.

Next, the following will explain the operation according to the embodiment.

The inventors conducted an experiment and the like and found that the stress applied to the cylindrical member 16 during the rotation of the rotor 15 gradually increases from the first welding portion 30 toward the first fitting portion 18a. FIG. 3 shows a measurement result of the stress applied to the cylindrical member 16 at several points from the first welding portion 30 to the part of the cylindrical member 16 facing the first fitting portion 18a in the radial direction of the cylindrical member 16 during the rotation of the rotor 15.

In FIG. 3, the vertical axis represents stress applied to the cylindrical member 16 at the points from the first welding portion 30 to the part of the cylindrical member 16 facing the first fitting portion 18a in the radial direction of the cylindrical member 16 during the rotation of the rotor 15. In FIG. 3, the horizontal axis represents the points from the first welding portion 30 to the part of the cylindrical member 16 facing the first fitting portion 18a in the radial direction of the cylindrical member 16 by using coordinate system. The coordinate (0) represents the first welding portion 30. Specifically, the coordinate (0) represents the boundary of the opening end face of the first end 16a of the cylindrical member 16 and the first flange portion 18c before the cylindrical member 16 and the first flange portion 18c are connected to each other via the first welding portion 30. Accordingly, the coordinate (0) represents the center of the first welding portion 30 in the axial direction of the cylindrical member 16. FIG. 3 shows that a larger number of the coordinate indicates a point closer to the first fitting portion 18a and more distant from the first welding portion 30. In FIG. 3, the coordinate (8) represents a point corresponding to a part of the cylindrical member 16 overlapped with the end face 180a of the first fitting portion 18a in the radial direction of the cylindrical member 16.

As indicated by the solid line L1 in FIG. 3, for example, the stress is constant at a local minimum value min from the coordinate (0) to the coordinate (1). The portion of the cylindrical member 16 corresponding to the coordinate (1) is a portion between the first welding portion 30 and the first fitting portion 18a. Accordingly, the whole of the first welding portion 30 is further spaced from the first fitting portion 18a than the portion of the cylindrical member 16 corresponding to the coordinate (1) in the axial direction of the cylindrical member 16. The stress gradually increases from the point on the coordinate (1) toward the point on the coordinate (8). Accordingly, the stress applied to the cylindrical member 16 during the rotation of the rotor 15 gradually increases from the part of the cylindrical member 16 corresponding to the coordinate (1) toward the first fitting portion 18a.

Press-fitting the first fitting portion 18a of the first shaft member 18 onto the inner peripheral surface 160 of the cylindrical member 16 causes the cylindrical member 16 to be subjected to the fitting stress from the first fitting portion 18a. Accordingly, in the cylindrical member 16, the fitting stress applied to the cylindrical member 16 from the first fitting portion 18a more easily transfers to a point closer to the first fitting portion 18a in the axial direction of the cylindrical member 16. Furthermore, during the rotation of the rotor 15, the cylindrical member 16 is subjected to another stress caused by a centrifugal force generated by the rotation of the rotor 15.

Since the stress gradually increases from the point on the coordinate (1) toward the point on the coordinate (8) as indicated by the solid line L1 in FIG. 3, it is conceivable that a portion of the cylindrical member 16 between the point represented by the coordinate (1) and the first fitting portion 18a is subjected to the fitting stress applied from the first fitting portion 18a to the cylindrical member 16.

In contrast, since the stress is constant at the local minimum value min from the coordinate (0) to the coordinate (1), it is conceivable that a portion of the cylindrical member 16 between the point represented by the coordinate (1) and the first welding portion 30 is not subjected to the fitting stress applied from the first fitting portion 18a to the cylindrical member 16 and is only subjected to the stress caused by a centrifugal force generated by the rotation of the rotor 15.

In the present embodiment, the first small-diameter portion 18b is disposed between the first fitting portion 18a and the first welding portion 30, and the first welding portion 30 is spaced from the first fitting portion 18a in the axial direction of the cylindrical member 16, and the first welding portion 30 is, given on the coordinate (0), subjected to the stress at the local minimum value min during the rotation of the rotor 15. That is, the first welding portion 30 is spaced from the first fitting portion 18a in the axial direction of the cylindrical member 16 so that the stress applied to the first welding portion 30 during the rotation of the rotor 15 is the local minimum value σmin. Accordingly, the fitting stress applied from the first fitting portion 18a to the cylindrical member 16 is unlikely to transfer to the first welding portion 30. This prevents the first welding portion 30 from being subjected to the fitting stress applied from the first fitting portion 18a to the cylindrical member 16, thereby suppressing the decrease of the strength of the connection between the first shaft member 18 and the cylindrical member 16 via the first welding portion 30.

A measurement result of the stress applied to the cylindrical member 16 at several points from the second welding portion 31 to the part of the cylindrical member 16 facing the second fitting portion 19a in the radial direction of the cylindrical member 16 during the rotation of the rotor 15 is similar to the measurement result shown in FIG. 3. Accordingly, in the second welding portion 31, the second small-diameter portion 19c is disposed between the second fitting portion 19a and the second welding portion 31, and the second welding portion 31 is spaced from the second fitting portion 19a in the axial direction of the cylindrical member 16, and the second welding portion 31 is, given on the coordinate (0), subjected to the stress at the local minimum value min during the rotation of the rotor 15. That is, the second welding portion 31 is spaced from the second fitting portion 19a in the axial direction of the cylindrical member 16 so that the stress applied to the second welding portion 31 during the rotation of the rotor 15 is the local minimum value σmin. Accordingly, the fitting stress applied from the second fitting portion 19a to the cylindrical member 16 is unlikely to transfer to the second welding portion 31. This prevents the second welding portion 31 from being subjected to the fitting stress applied from the second fitting portion 19a to the cylindrical member 16, thereby suppressing the decrease of the strength of the connection between the second shaft member 19 and the cylindrical member 16 via the second welding portion 31.

The aforementioned embodiment provides the following advantageous effects.

(1) The fitting stress applied to the cylindrical member 16 from the first fitting portion 18a is unlikely to transfer to the first welding portion 30 since the first welding portion 30 is spaced from the first fitting portion 18a in the axial direction of the cylindrical member 16. Furthermore, the fitting stress applied to the cylindrical member 16 from the second fitting portion 19a is unlikely to transfer to the second welding portion 31 since the second welding portion 31 is spaced from the second fitting portion 19a in the axial direction of the cylindrical member 16. This prevents the first welding portion 30 and the second welding portion 31 from being subjected to the fitting stress applied from the first fitting portion 18a and the second fitting portion 19a to the cylindrical member 16, respectively. This therefore suppresses the decrease of the strength of the connection between the first shaft member 18 and the cylindrical member 16 via the first welding portion 30 and the decrease of the strength of the connection between the second shaft member 19 and the cylindrical member 16 via the second welding portion 31. As a result, this increases the reliability of the rotor of the rotating electrical machine 10.

(2) The first small-diameter portion 18b is disposed between the first fitting portion 18a and the first welding portion 30 in the axial direction of the cylindrical member 16, so that the first welding portion 30 is spaced from the first fitting portion 18a without a design change of the cylindrical member 16. The second small-diameter portion 19c is disposed between the second fitting portion 19a and the second welding portion 31 in the axial direction of the cylindrical member 16, so that the second welding portion 31 is spaced from the second fitting portion 19a without a design change of the cylindrical member 16.

(3) The first welding portion 30 via which the cylindrical member 16 and the first shaft member 18 are welded together is spaced from the first fitting portion 18a in the axial direction of the cylindrical member 16, and this configuration prevents the first welding portion 30 from being subjected to the fitting stress applied from the first fitting portion 18a to the cylindrical member 16. This therefore suppresses the decrease of the strength of the connection between the first shaft member 18, which is likely to be subjected to a load, and the cylindrical member 16 via the first welding portion 30. As a result, this increases the reliability of the rotor 15 of the rotating electrical machine 10.

(4) When the first welding portion 30 is spaced from the first fitting portion 18a in the axial direction of the cylindrical member 16 so as to prevent the first welding portion 30 from being subjected to the fitting stress applied to the cylindrical member 16 from the first fitting portion 18a, the first welding portion 30 is only subjected to the stress caused by a centrifugal force generated by the rotation of the rotor 15, which causes the stress applied to the first welding portion 30 to be the local minimum value. Accordingly, the first welding portion 30 is spaced from the first fitting portion 18a in the axial direction of the cylindrical member 16 so that the stress applied to the first welding portion 30 during the rotation of the rotor 15 is the local minimum value σmin. This configuration allows the first welding portion 30 to be only subjected to the stress caused by the centrifugal force generated by the rotation of the rotor 15 when the rotor 15 rotates, thereby further suppressing the decrease of the strength of the connection between the first shaft member 18 and the cylindrical member 16. When the second welding portion 31 is spaced from the second fitting portion 19a in the axial direction of the cylindrical member 16 so as to prevent the second welding portion 31 from being subjected to the fitting stress applied to the cylindrical member 16 from the second fitting portion 19a, the second welding portion 31 is only subjected to the stress caused by the centrifugal force generated by the rotation of the rotor 15, which causes the stress applied to the second welding portion 31 to be the local minimum value. Accordingly, the first welding portion 30 is spaced from the first fitting portion 18a in the axial direction of the cylindrical member 16 so that the stress applied to the first welding portion during the rotation of the rotor 15 is the local minimum value σmin. This configuration allows the first welding portion 30 to be only subjected to the stress caused by the centrifugal force generated by the rotation of the rotor 15 when the rotor 15 rotates, thereby further suppressing the decrease of the strength of the connection between the first shaft member 18 and the cylindrical member 16. This configuration therefore further increases the reliability of the rotor 15 of the rotating electrical machine 10.

(5) For example, the first end 16a of the cylindrical member 16 and the first flange portion 18c may be welded together with the first end 16a and the first flange portion 18c displaced from each other if fitting stress is excessively applied to a welding portion when the cylindrical member 16 and the first shaft member 18 are welded together, which may lead to a welding defect. In this regard, when the welding portion is spaced from the first fitting portion 18a in the axial direction of the cylindrical member 16, the fitting stress applied to the welding portion is reduced. This reduces the displacement of the first end 16a of the cylindrical member 16 and the first flange portion 18c, thereby suppressing the occurrence of welding defects.

This embodiment may be modified as below. The embodiment may be combined with the following modification examples within a technically consistent range.
In the embodiment, the first shaft member 18 may be provided without the first small-diameter portion 18b, and the inner diameter of a part of the cylindrical member 16 between the part of the cylindrical member 16 onto which the first fitting portion 18a is fitted and the first welding portion 30 may be increased so that the first welding portion 30 is spaced from the first fitting portion 18a in the axial direction of the cylindrical member 16. The second shaft member 19 may be provided without the second small-diameter portion 19c, and the inner diameter of a part of the cylindrical member 16 between the part of the cylindrical member 16 onto which the second fitting portion 19a is fitted and the second welding portion 31 may be increased so that the second welding portion 31 is spaced from the second fitting portion 19a in the axial direction of the cylindrical member 16.
The magnetic material according to the embodiment is not limited to the permanent magnet 17, and examples of the magnetic material may include a laminated core, an amorphous core, and a powder core.
In the embodiment, an end of the second shaft portion 19b of the second shaft member 19 distant from the second small-diameter portion 19c may be provided with the impeller 23. The impeller 23 is rotatable together with the second shaft member 19. The impeller 23 is driven by a drive force generated and transmitted by rotation of the second shaft member 19. Accordingly, the second shaft member 19 provided with the impeller 23 serves as the output shaft that is configured to output the drive force. That is, at least one of the first shaft member 18 and the second shaft member 19 has to serve as the output shaft that is configured to output the drive force.
In the embodiment, the cylindrical member 16 may be made of a metallic material, such as nickel alloy.
The end face 180a of the first fitting portion 18a is in contact with the end face 17a of the permanent magnet 17 in the embodiment, but the end face 180a of the first fitting portion 18a may be spaced from the end face 17a of the permanent magnet 17. The end face 190a of the second fitting portion 19a is in contact with the end face 17b of the permanent magnet 17 in the embodiment, but the end face 190a of the second fitting portion 19a may be spaced from the end face 17a of the permanent magnet 17.
In the embodiment, the first welding portion 30 may be located closer to the first fitting portion 18a as long as the stress applied to the first welding portion 30 during the rotation of the rotor 15 is the local minimum value σmin. For example, the center of the first welding portion 30 may be located closer to the coordinate (1) than to the coordinate (0) indicated by the solid line L1 in FIG. 3. In this case, the first welding portion 30 needs to be located closer to the first fitting portion 18a while the whole of the first welding portion 30 is more distant from the first fitting portion 18a than the portion of the cylindrical member 16 corresponding to the coordinate (1) in the axial direction of the cylindrical member 16.
In the embodiment, the first welding portion 30 may be located at a position where the stress applied to the first welding portion 30 during the rotation of the rotor 15 is larger than the local minimum value σmin. For example, the center of the first welding portion 30 may be located at a position represented by a coordinate closer to the first fitting portion 18a than to the coordinate (1) indicated by the solid line L1 in FIG. 3. In this configuration, the first welding portion 30 needs to be spaced from the first fitting portion 18a in the axial direction of the cylindrical member 16. In this configuration, the fitting stress applied to the cylindrical member 16 from the first fitting portion 18a is also unlikely to transfer to the first welding portion 30, as compared with a configuration in which the first welding portion 30 is not spaced from the first fitting portion 18a in the axial direction of the cylindrical member 16 and is continuous to the first fitting portion 18a in the axial direction of the cylindrical member 16, for example.

### REFERENCE SIGNS LIST

10 . . . rotating electrical machine
15 . . . rotor
16 . . . cylindrical member
17 . . . permanent magnet serving as a magnetic material
18 . . . first shaft member serving as a shaft member and an output shaft
18a . . . first fitting portion serving as a fitting portion
18b . . . first small-diameter portion serving as a small-diameter portion
19 . . . second shaft member serving as a shaft member
19a . . . second fitting portion serving as a fitting portion
19c . . . second small-diameter portion serving as a small-diameter portion
30 . . . first welding portion serving as a welding portion
31 . . . second welding portion serving as a welding portion

1. A rotor of a rotating electrical machine, comprising:
a cylindrical member;
a magnetic material disposed inside the cylindrical member;
a shaft member disposed on at least one of opposite ends of the cylindrical member in an axial direction of the cylindrical member and fixed to an inner peripheral surface of the cylindrical member with the shaft member located adjacent to the magnetic material in the axial direction of the cylindrical member; and
a welding portion via which the cylindrical member and the shaft member are welded together, wherein
the shaft member has a fitting portion that is press-fitted onto the inner peripheral surface of the cylindrical member,
wherein
the fitting portion is located closer to the magnetic material than to the welding portion, and
the welding portion is spaced from the fitting portion in the axial direction.

2. The rotor of the rotating electrical machine according to claim 1, wherein
the shaft member has a small-diameter portion that has a dimension smaller than a dimension of the fitting portion in a radial direction of the cylindrical member and is disposed inside the cylindrical member, and
the small-diameter portion is disposed between the fitting portion and the welding portion in the axial direction.

3. The rotor of the rotating electrical machine according to claim 1, wherein
the shaft member serves as an output shaft that is configured to output a drive force.

4. The rotor of the rotating electrical machine according to claim 1, wherein
the welding portion is spaced from the fitting portion in the axial direction so that stress applied to the welding portion during rotation of the rotor is a local minimum value.
